(19) United States
(12) Patent Application Publication
(10) Pub. No.: US 2008/0264990 A1
(43) Pub. Date: Oct. 30, 2008

(54) LIFT FOR AN ALL-TERRAIN VEHICLE

(75) Inventors: William Riegert, Edwardsville, IL (US); Curt Klaustermeier, St. Jacob, IL (US)

Correspondence Address: POLSINELLI SHALTON FLANIGAN SUELTHAUS PC, 700 W. 47TH STREET, SUITE 1000, KANSAS CITY, MO, 64112-1802, US

(73) Assignee: William Riegert, Edwardsville, IL (US)

(21) Appl. No.: 11/739,385

(22) Filed: Apr. 24, 2007

(51) Int. Cl. B60R 9/06

(52) U.S. Cl. 224/519

(57) ABSTRACT

A lifting apparatus for an all-terrain vehicle is described. The lifting apparatus assists in the loading, transferring, and unloading of an article or a load from the all-terrain vehicle. The lifting apparatus includes an elevating member with a platform. The platform is engaged to the elevating member for vertical movement. A winch is mounted on the elevating member and connected to the platform to raise and lower the platform. A base member supports the elevating member in a rotatable engagement such that elevating member and the platform rotate relative to the base member.

### FIELD OF INVENTION

The present invention relates to a lifting apparatus for an all-terrain vehicle.

### BACKGROUND OF INVENTION

All-terrain vehicles are commonly used by farmers, hunters, and others to carry or haul heavy or awkward loads. Most all-terrain vehicles include a rack positioned behind the driver's seat and above the rear axle to receive the load. The rack is often composed of cross-linking tubular elements. As the rack may be approximately four feet above the ground, it may be difficult or inconvenient to manually lift a heavy or awkward load up on to the rack of the all-terrain vehicle.

### SUMMARY

Described herein are embodiments for a lifting apparatus for an all-terrain vehicle that assists in the loading, transferring, and unloading of an article or a load from the all-terrain vehicle. The lifting apparatus allows the user to place the load on a lowered platform of the lifting apparatus and elevate the load on the platform using the lifting apparatus. The platform may then be rotated to a travel position on which the platform is resting over the rear axle of the all-terrain vehicle. The lifting apparatus may be conveniently removed from the all-terrain vehicle after its use.

### BRIEF DESCRIPTION OF FIGURES

FIG. 1 is a perspective view of the lifting apparatus connected to the all-terrain vehicle.

FIG. 2 is a perspective view of the lifting apparatus.

FIG. 3 is a view of the upper portion of the elevating member of the lifting apparatus.

FIG. 4 is a view of the movable connection between the elevating member and the platform.

FIG. 5 is a view of lifting apparatus connected to the all-terrain vehicle with the platform removed.

FIG. 6 is a view of the carriage.

FIG. 7 is a view of the elevating member and the support member.

FIG. 8 is a partial view of the elevating member and the support member.

FIG. 9 is a perspective view of the lifting apparatus connected to the all-terrain vehicle in the travel position.

FIG. 10 is a perspective view of the lifting apparatus connected to the all-terrain vehicle with the platform partially rotated.

FIG. 11 is a perspective view of the lifting apparatus connected to the all-terrain vehicle in the lifting position.

FIG. 12 is a perspective view of the lifting apparatus connected to the all-terrain vehicle in the lifting position with the platform fully lowered.

FIG. 13 is a view of is a perspective view of the lifting apparatus connected to the all-terrain vehicle in the travel position with a load on the platform.

FIG. 14 is a view of the auxiliary receiver.

FIG. 15 is a view of the auxiliary receiver receiving the support member to connect the lifting apparatus to the all-terrain vehicle.

FIG. 16 is a view of the bracket/spring member.

FIG. 17 is a view of the lifting apparatus connecting to directly to the receiver of the all-terrain vehicle.

### DETAILED DESCRIPTION

The lifting apparatus includes an elevating and rotatable platform for supporting and carrying a load. The platform may be lowered to at or near ground level, and the load may be simply rolled or placed onto the platform without the work of lifting the load to a heightened position. The lifting apparatus will then mechanically raise the platform to a height of up to approximately six to eight feet above ground level. The platform of the lifting apparatus may rotate to a position in which the load is over the rear portion of the all-terrain vehicle, and the platform may then be lowered to a resting position on the rack of the all-terrain vehicle suitable for travel. The platform of the lifting apparatus may again further raise and rotate to a position for transferring the elevated load into the bed of a pickup truck, onto a loading dock, or other heightened receiving area. Or, the platform may again further raise, rotate, and lower back to at or near ground level.

The lifting apparatus comprises an elevating member comprising the platform. The platform is moveably engaged to the elevating member. A winch or other winding means is mounted on the elevating member. The winch is connected to the platform to mechanically raise and lower the platform. A base member supports the elevating member in a rotatable engagement, such that the elevating member rotates relative to the base member.

The platform may be movably connected to the elevating member by a carriage that travels in a moveable engagement with the elevating member. The platform comprises a carrying surface for the load.

The platform is movably connected to the elevating member such that the platform may move in an up vertical direction and in a down vertical direction. The elevating member forms a shaft or track for the moving platform. The elevating member supports the platform and directs its movement in conjunction with the shaft or track.

The lifting apparatus finds utility for any occasion in which a user of an all-terrain vehicle wishes to load and unload a heavy or bulky item onto the all-terrain vehicle. The lifting apparatus is especially useful for hunters of large game animals, such as white-tailed deer. Hunters routinely use all-terrain vehicles to travel to remote hunting locations, which may include hilly or rough terrain and to haul their harvested game animals. A white-tailed deer commonly weighs 150 to 250 pounds. After harvesting a white-tailed deer, the hunter must transfer the deer to their destination, such as their vehicle, home, processing facility, wildlife check-in facility, etc. This may prove especially burdensome to the solo hunter or the hunter having special needs. The hunter must lift the heavy, awkward deer up to the top of the rack. The lifting apparatus assists hunters in loading and transferring the harvested game animal onto the rack of their all-terrain vehicle for convenient travel to their desired destination.

The present invention further finds utility in an agricultural setting. Farm materials, including bags of seed, fertilizer, feed, etc., may be loaded onto the elevated platform of the lifting apparatus directly from the bed of a truck or from the bucket of a tractor. The farm materials may then be transported on the all-terrain vehicle about the farm.

The lifting apparatus will now be described with reference to the accompanying figures.

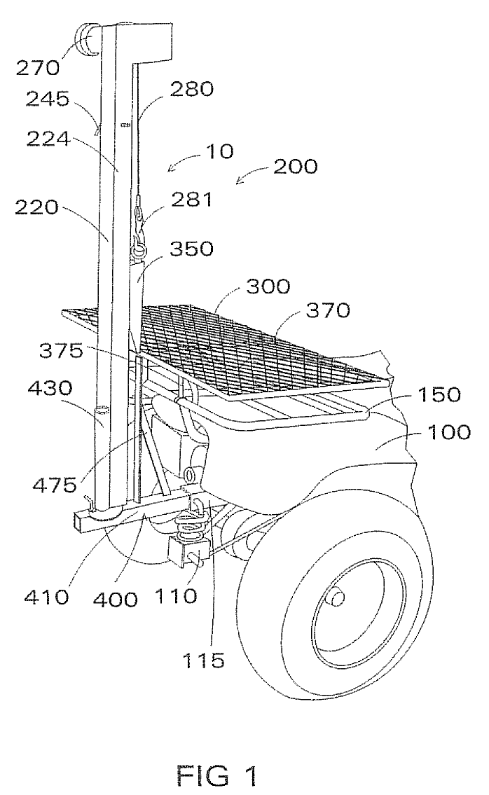

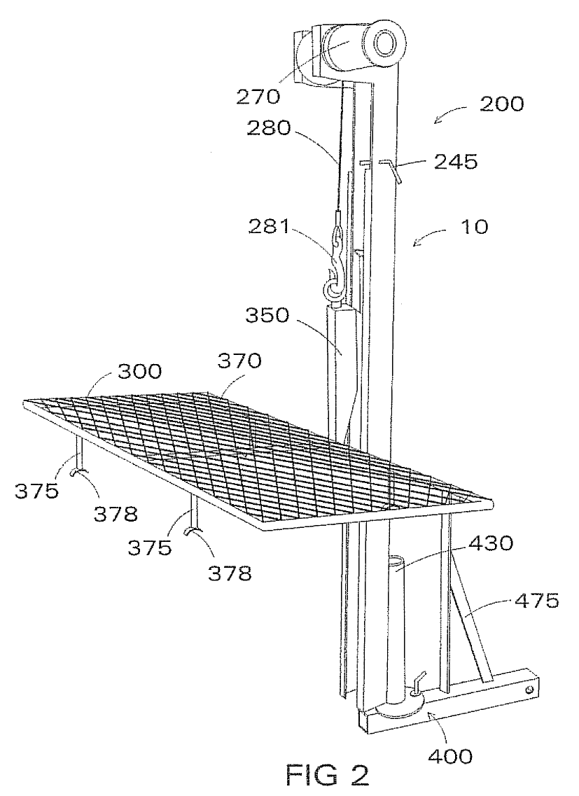

A lifting apparatus 10 is shown in FIGS. 1 and 2. The lifting apparatus 10 is connected to an all-terrain vehicle 100. The lifting apparatus 10 generally comprises an elevating member 200, a platform 300 and a base member 400. The elevating member 200 holds the platform 300 in a vertically moveable engagement. The elevating member 200 is rotatably connected to the base member 400. The base member 400 is connected to the all-terrain vehicle 100.

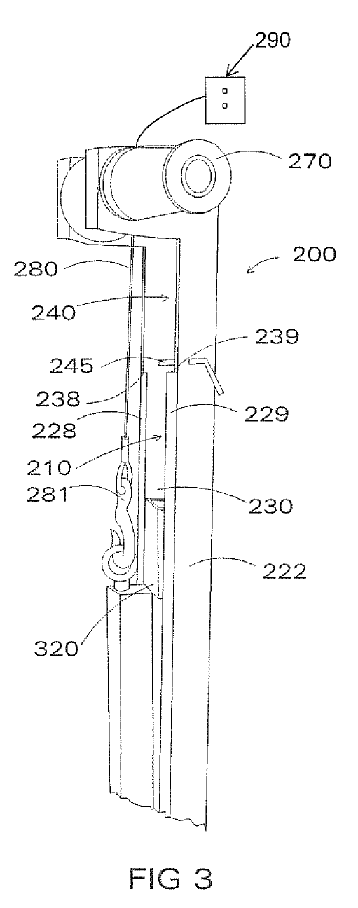

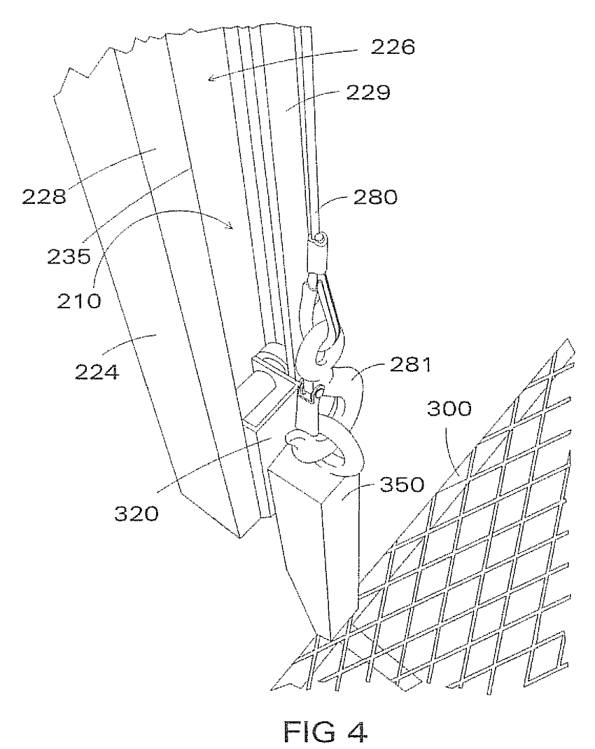

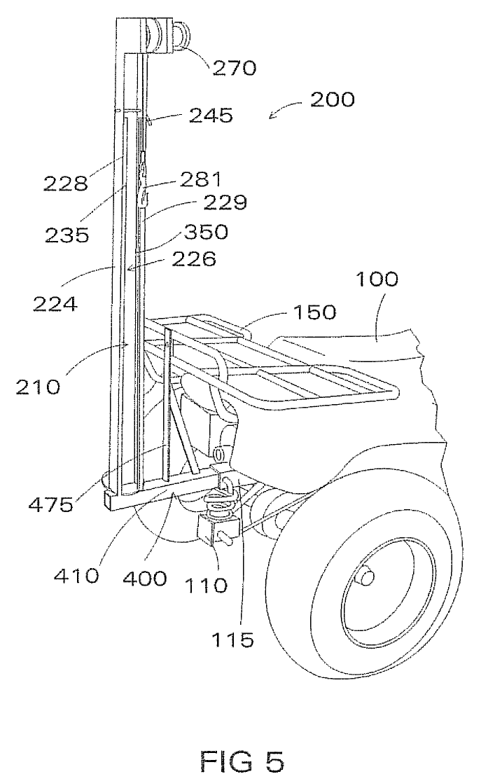

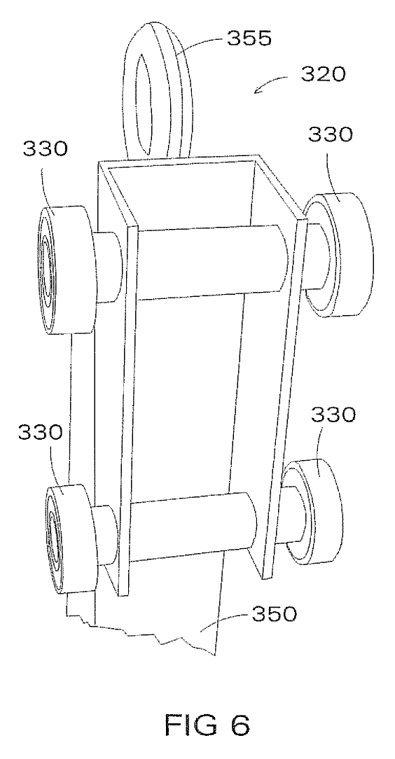

The elevating member 200 will be described in detail with reference to FIGS. 3-6. The elevating member 200 is a generally straight member, with a length of approximately three feet to approximately eight feet for all-terrain vehicle applications. The elevating member 200 defines a guide channel 210 for directing the movement of a carriage 320. The guide channel 210 is a substantially hollow shaft for containing the movement of the carriage 320. In other embodiments, the guide channel 210 may be a track. The guide channel 210 permits the carriage 320 to travel proximate to the elevating member 200 in an up vertical direction and in a down vertical direction. In the embodiment shown in FIG. 4, the carriage 320 is positioned substantially inside of the elevating member 200 to travel up and down the guide channel 210. The carriage 320 is connected to the platform 300. The guide channel 210 allows the carriage 320 to move in a vertical and linear fashion for the elevation and lowering of the platform 300.

The elevating member 200 may be formed from a two-inch square tube having four sides, namely a backside 220, a right side 222, a left side 224 and a front side 226. Portions of the front side 226 may be cut-out or removed. These four sides of the elevating member form the guide channel 210. The front side 226 includes a slot 230 that defines travel limits for the carriage 320. The front side 226 includes a first front side member 228 and a second front side member 229. The front and second side members 228 and 229 form an opening rim 235 of the slot 230, which assists in defining the guide channel 210.

A channel pin 245 obstructs the slot 230 at an upper portion of the elevating member 200. The channel pin 245 is removably inserted generally perpendicular to the overall orientation of the elevating member 200. The channel pin 245 prevents the carriage 320 from exiting the elevating member 200 unless the channel pin 245 is removed. The channel pin 245 further provides a stop mechanism to prevent a winch cable 280 from pulling the carriage 320 from the guide channel 210 or all the way to a winch 270.

Above the channel pin 245, a channel opening 240 is provided which allows the carriage 320 to be removed from the guide channel 210. As such, the user may remove the channel pin 245 and slide the carriage 320 to the channel opening 240 to remove the carriage 320 from the guide channel 210. This allows the user to separate the platform 200 from the elevating member 300 for more convenient storage. The channel opening 240 is formed by top edges 238 and 239 of the front side member 228 and the second front side member 229. The elevating member 200 thus forms a guide channel 210 for the movement of the carriage 320.

On an upper portion of the elevating member 200, the winch 270 is mounted to the elevating member 200. The winch 270 includes the winch cable 280 that connects to the platform 300. A winch control 290 provides the user controls for the operation of the winch 270. Winch wiring electrically connects the winch 270 to the batteries of the all-terrain vehicle to power the winch 270. The winch 270 should be capable of lifting approximately 250 pounds or more to provide the lifting capability for the lifting apparatus 10. An example of a suitable winch is a Super Winch T1500. Other suitable winches may be commercially available from the Warn Winch Company.

The platform 300 will now be described. The platform 300 includes a carrying surface 370 for holding the game animal, farm materials, etc. The carrying surface may include a flat metal mesh surface, a basket, a guide structure, a rack, or any other structure suitable for holding or securing a load. The carrying surface 370 is mounted to a lift arm 350. The lift arm 350 is mounted to the carriage 320. The lift arm 350 may include a structure with a size small enough to enter the slot 230 and mount to the carriage 320 traveling within the guide channel 210. In this embodiment, the carriage 320 includes wheel bearings 330 that provide for the travel within the guide channel 210. The carriage 320 may comprise a plurality of the wheel bearings 330. In the embodiment depicted, four wheel bearings 330 are utilized. The lift arm 350 further includes a lift arm connection 355 to receive the winch cable 280. The lift arm connection 355 is generally on the opposite side of the lift arm 350 from the carrying surface 370. In this embodiment, the lift arm connection 355 is an eye-loop that receives a hook 281 attached to the winch cable 280.

The carrying surface 370 may include one or more supports 375. The supports 375 may rest on a rack 150 of the all-terrain vehicle. The supports 375 assist in supporting the weight of the load on the rack 150. The supports 375 may include a U-shaped member 378 to fit over tubular structures on the rack 150.

The bottom portion of the elevating member 200 is preferably closed or substantially closed with a metal plate to prevent the platform 300 from sliding out the bottom of the guide channel 210.

The base member 400 will now be described. The base member 400 includes a support member 410 that is received by a receiver 110 of the all-terrain vehicle 100 or is received by an auxiliary receiver 115. The base member 400 generally supports the elevating member 200.

The base member 400 includes an axis 420 that is securely mounted to or through the support member 410 in a perpendicular manner. The axis 420 may include a one-inch round piece of stock material. A pipe 430 is affixed around the axis 420 in a rotatable engagement using bearings 440. The pipe 430 is affixed to the elevating member 200 through a weld that preferably runs most of a contact region between the pipe 430 and the elevating member 200. A circle 450 is further welded around the perimeter of the pipe 430 and further underneath a bottom portion of the elevating member 200. The circle 450 may serve to close the elevating member 200. As such, the elevating member 200, the pipe 430 and the circle 450 all rotate about the axis 420. The circle 450 includes holes on opposite sides of the circle 450 for a stop pin 460 in a elevating position 454 and a travel position 456. The elevating position 454 and travel position 456 may be holes bored through the support member 410. The pipe 430 rotates around the axis 420 in increments of 180°.

The base member 400 may include one or more optional base supports 475 that connect the base member 400 and the rack 150. The base supports 475 assist in securing and stabilizing the lifting apparatus, although most of the weight of the lifting apparatus 10 is supported by the receiver 110 or the auxiliary receiver 115. The structure and positioning of the base supports 475 will vary depending on the particular all-terrain vehicle receiving the lifting apparatus 10.

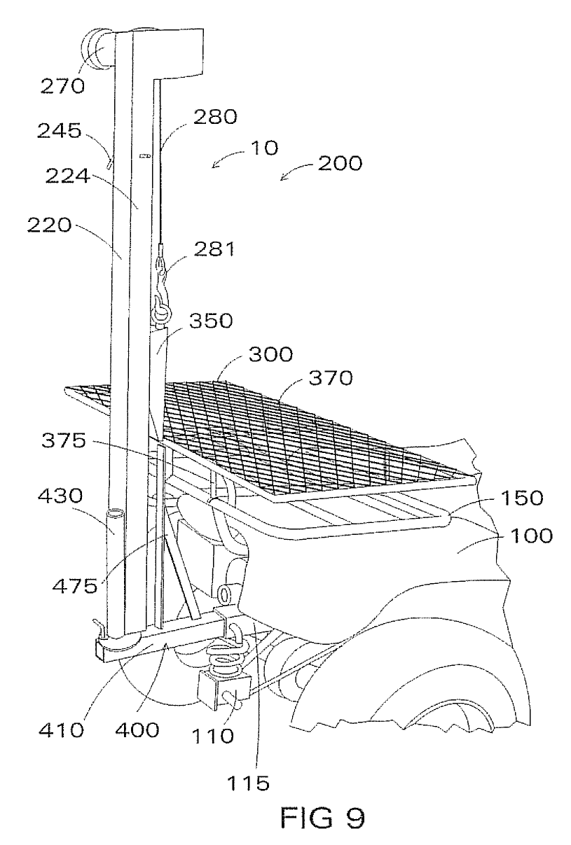

The operation of the lifting apparatus 10 will now be described with reference to FIGS. 9-13. Generally, the elevating member 200 and the base member 400 remain fully connected and should not be disassembled by the end user, although the platform 300 may easily be removed from the elevating member 200 as described above. The support member 410 is attached to the all-terrain vehicle at the receiver 110 or the auxiliary receiver 115. Next, the platform 300 is engaged to the guide channel 210 by inserting the carriage 320 into the channel opening 240. Next, the winch cable 280 is connected to the lift arm connection 355. The platform 300 may be raised by operation of the winch 270.

Next, the user rotates the elevating member 200 relative to the support member 410 such that the platform 300 is positioned over the rear of the all-terrain vehicle. The user secures the elevating member 200 in a travel position by inserting the stop pin 460 into the travel position 454 (shown in FIG. 9). The platform 300 may be lowered until it rests on the rack 150. In the travel position, the platform 300 is positioned over the rear of the all-terrain vehicle. The all-terrain vehicle 100 may now travel under its normal operation. The all-terrain vehicle 100 could be loaded into the bed of a pickup truck, since it has a reduced outline due to the rotatable engagement of the elevating member 200 to the support member 410. Further, the all-terrain vehicle 100 may travel easier through the woods or around a farm, since the platform 300 is not extending beyond the rear of the vehicle, which could create a problem if the all-terrain vehicle was crossing a creek or backing up.

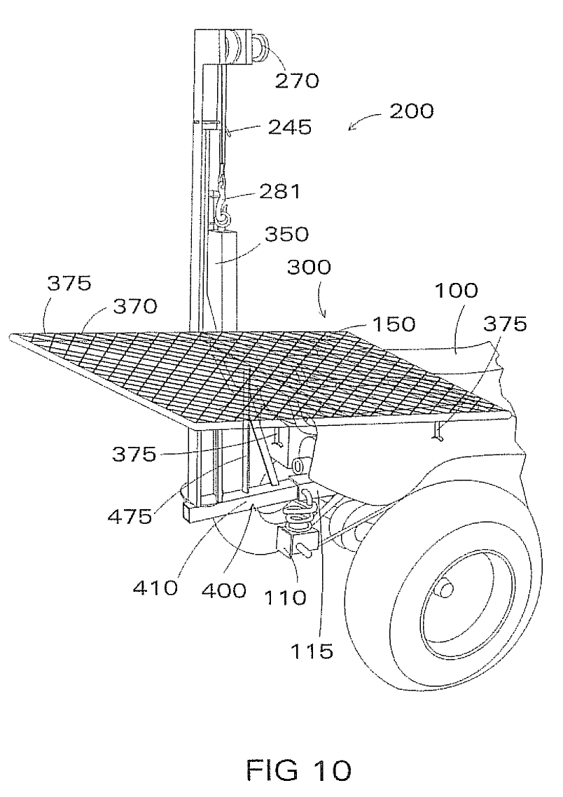

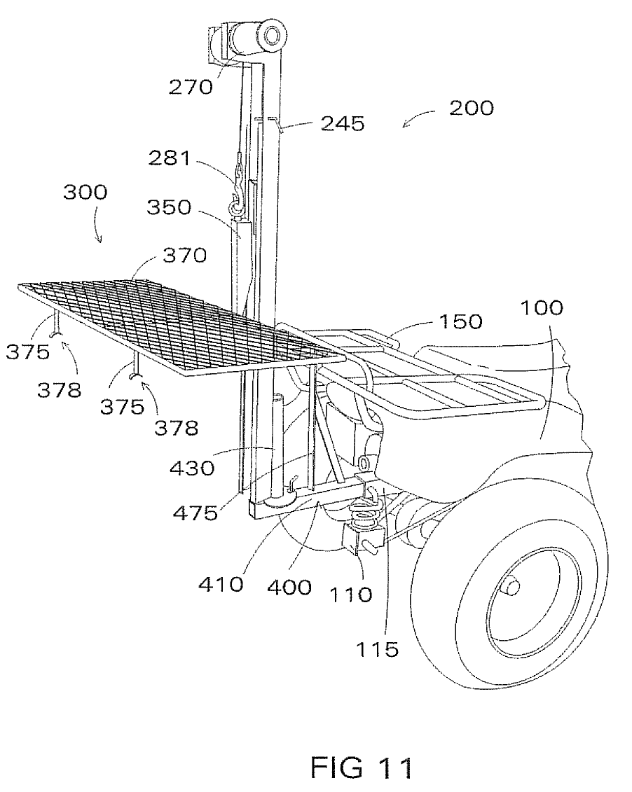

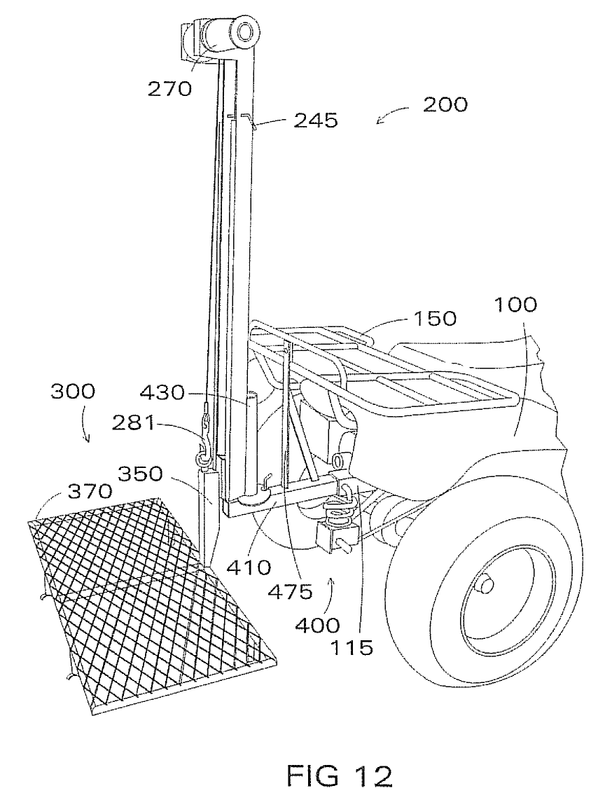

When it is time to load the carrying surface 370, the stop pin 460 is removed from the travel position 454 and the elevating member 200 is rotated (shown in FIG. 10) approximately 180° relative to the base member 400. The stop pin 460 is reinserted into the elevating position 456 (shown in FIG. 11) to secure the elevating member 200 from further rotation. Next, the winch 270 may be operated to lower the platform 300 to a position (shown in FIG. 12) at or near ground level where, for example, farm materials or a game animal may be easily rolled or transferred at a low height to the carrying surface 370 of the platform 300. Next, the winch 270 may be operated, thus lifting the platform 300 to a heightened position. Next, the stop pin 460 is removed from the elevating position 456 and the elevating member 200 is rotated approximately 180° such that the stop pin may be placed in the travel position 454. The platform 300 may then be lowered such that the supports 375 rest on the basket 150.

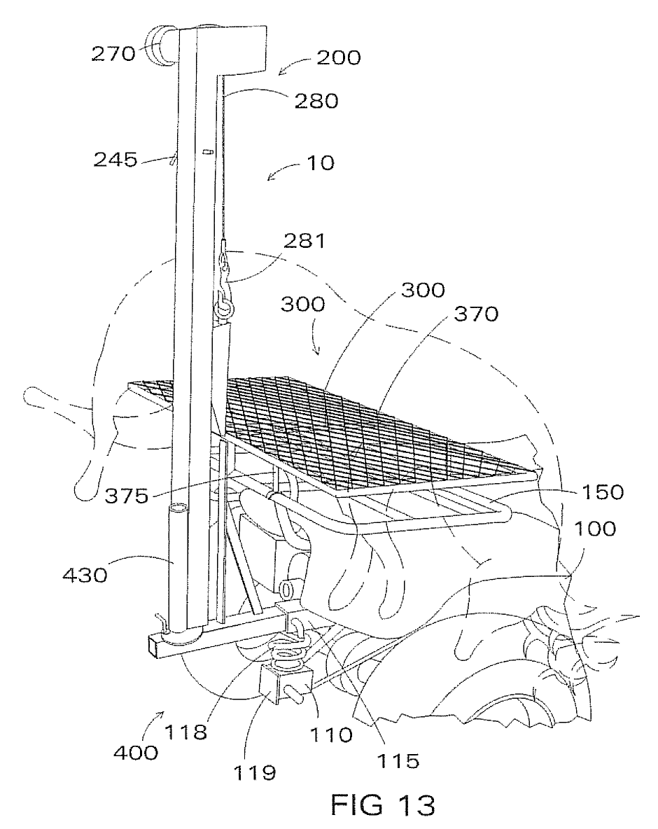

It is important to note that the load has now been transferred to a position located over the rear of the all-terrain vehicle 100 instead of being behind the all-terrain vehicle 100. With the load being positioned over the rear of the all-terrain vehicle 100, the weight of the load is generally over the axle on the all-terrain vehicle 100 (as shown in FIG. 13) and the stability of the all-terrain vehicle 100 is thus maintained. The user may then travel in a confident manner with the all-terrain vehicle 100. If the load was maintained behind the all-terrain vehicle 100, the weight of the load could throw off the stability of the all-terrain vehicle 100, i.e., the all-terrain vehicle 100 could be prone to tipping over or cause the all-terrain vehicle 100 to lose traction from its front wheels.

After driving with the load to a particular location, the elevating member 200 may be rotated and the platform 300 lifted to provide an easy transfer of the farm material or the game animal into the bed of a pickup, bucket of a farm implement, onto a loading dock, or other heightened position.

The various components of the present invention may be formed from a variety of metal materials including iron, iron alloys, aluminum, titanium, etc. One of ordinary skill in the art will recognize that certain components of the lift should be formed from the same or similar materials to allow for their connection through welding.

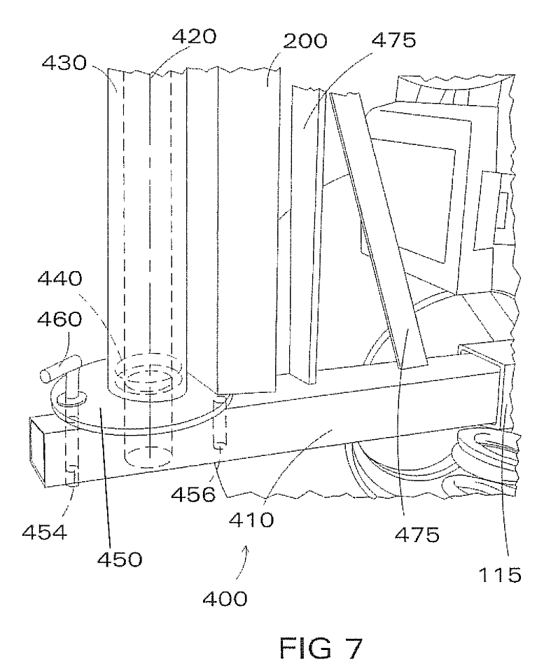

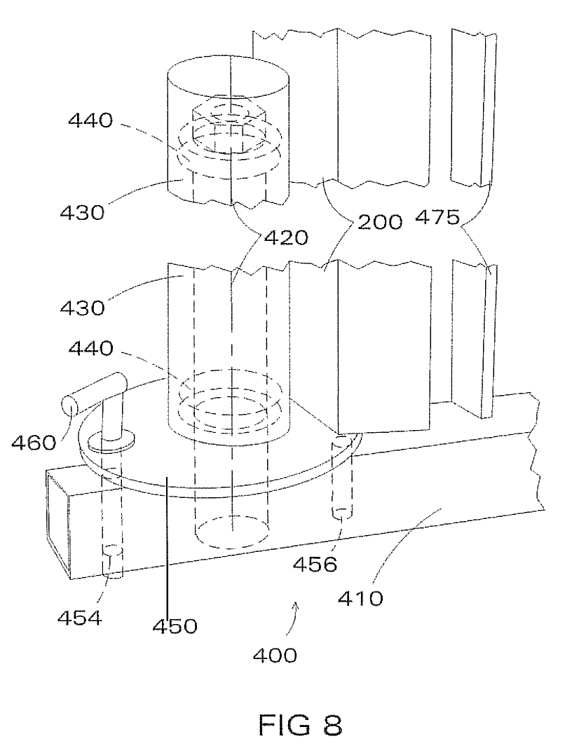

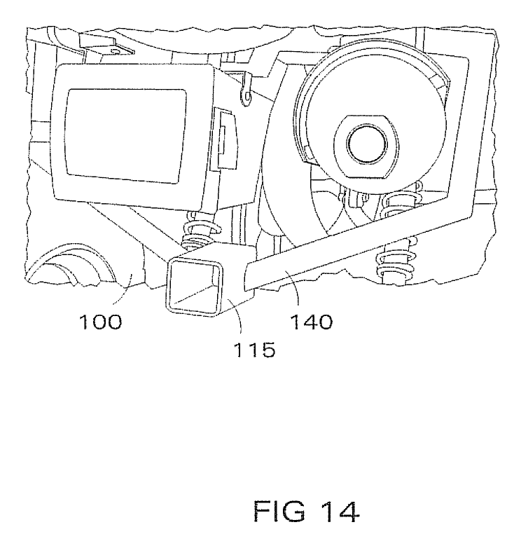

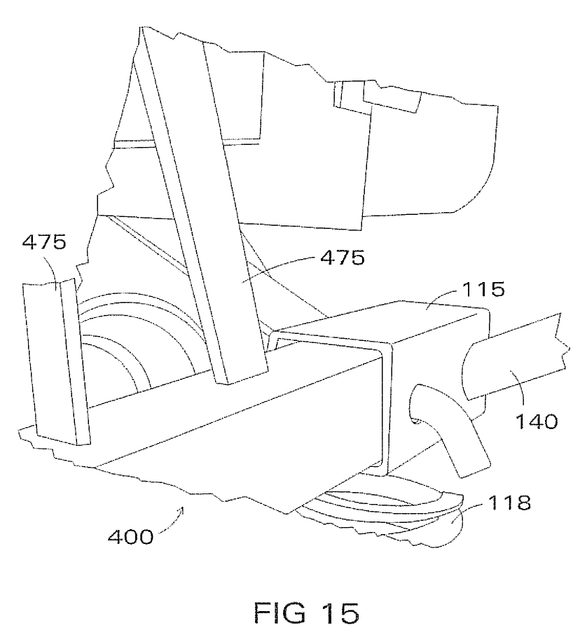

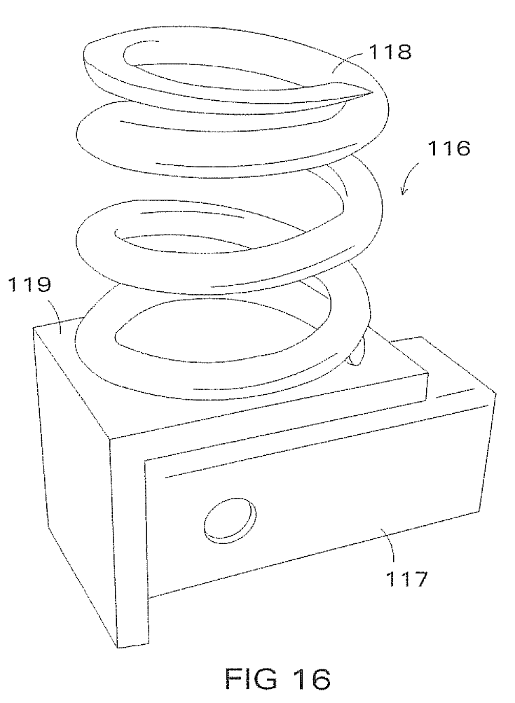

The embodiment of the lifting apparatus 10 depicted in FIGS. 1-16 includes attachment to the auxiliary receiver 115. The auxiliary receiver 115 rests on a bracket/spring member 116 that includes a plug 117 that is received by the all-terrain vehicle receiver 110. The bracket/spring member 116 includes a spring 118 to help support the weight of the rear of the all-terrain vehicle 100 with the load. As the load may be heavy and the rear of the all-terrain vehicle may bottom-out on the frame of the all-terrain vehicle driving over a bump, the spring 118 assists in support of the load. The spring 118 is mounted on top of a bracket 119. The bracket 119 is further mounted on the plug 117. The spring 118 may also be directly mounted to the top of the all-terrain vehicle receiver 110.

The auxiliary receiver 115 includes supports 140 that connect to the rack 150, frame of the all-terrain vehicle 100, or other suitable components of the all-terrain vehicle 100 capable of supporting weight to help stabilize the auxiliary receiver 115 and lifting apparatus 100.

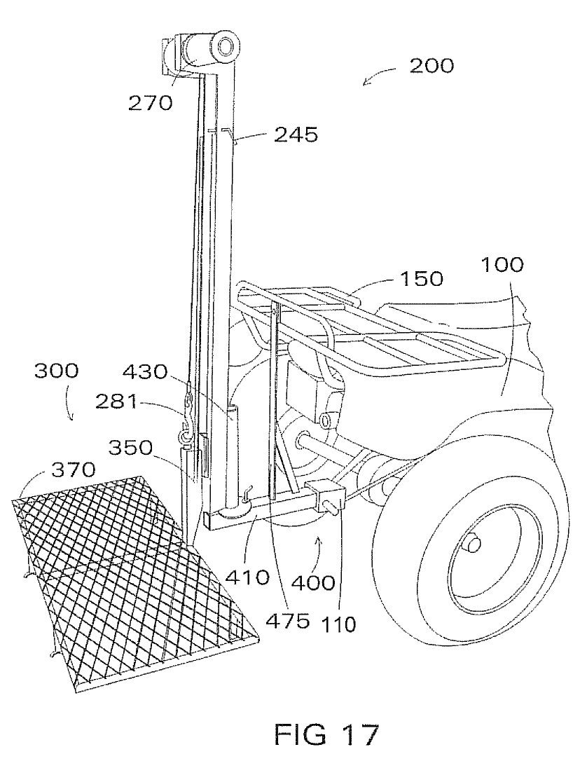

In other embodiments, the receiver 110 of the all-terrain-vehicle 100 may directly receive the support member 410 to connect the lifting apparatus 10 to the all-terrain vehicle 100. Such an embodiment is shown in FIG. 17. In this embodiment, the auxiliary receiver 115 and supports 140 are not needed.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present invention.

What is claimed:

1. A lifting apparatus for an all-terrain vehicle, comprising:
an elevating member comprising a platform, wherein the platform is engaged to the elevating member for vertical movement;
a winch mounted on the elevating member, the winch connected to the platform to raise and lower the platform; and
a base member that supports the elevating member in a rotatable engagement such that elevating member and the platform rotate relative to the base member.

2. The lifting apparatus according to claim 1, wherein the elevating member defines a guide channel.

3. The lifting apparatus according to claim 1, wherein the platform comprises a carriage.

4. The lifting apparatus according to claim 3, wherein the carriage travels proximate to the elevating member.

5. The lifting apparatus according to claim 3, wherein the carriage is positioned substantially inside of the elevating member.

6. The lifting apparatus according to claim 1, wherein the elevating member defines a guide channel, the platform comprises a carriage, and the guide channel directs the movement of the carriage.

7. The lifting apparatus according to claim 1, wherein the platform comprises a carrying surface, and the carrying surface connects to a lift arm, and the lift arm connects to a carriage.

8. The lifting apparatus according to claim 7, wherein the lift arm enters a slot formed by the elevating member.

9. The lifting apparatus according to claim 1, wherein the base member includes a support member, the support member comprising an axis mounted generally perpendicular to the support member.

10. The lifting apparatus according to claim 9, wherein a pipe is affixed around the axis in a rotatable engagement, and the elevating member is mounted to the pipe.

11. The lifting apparatus according to claim 10, wherein the pipe rotates around the axis in increments of 180°.

12. The lifting apparatus according to claim 1, further comprising an auxiliary receiver that receives the base member, wherein the auxiliary receiver is supported by a spring.

13. The lifting apparatus according to claim 12, wherein the spring is mounted onto a main receiver of the all-terrain vehicle.

14. The lifting apparatus according to claim 1, wherein the base member includes a support member that is received by a main receiver of the all-terrain vehicle to attach the lifting apparatus to the main receiver of the all-terrain vehicle.

15. The lifting apparatus according to claim 1, wherein the platform is separable from the elevating member.

16. The lifting apparatus according to claim 1, wherein the platform comprises a carriage, the elevating member defines a guide channel, the guide channel having a channel opening for removing the carriage from the guide channel.

17. The lifting apparatus according to claim 1, wherein the platform includes supports extending from the platform, wherein the supports rest on a rack of the all-terrain vehicle

18. A lifting apparatus for an all-terrain vehicle, comprising:
an elevating member that forms a channel, the elevating member comprising a winch;
a platform comprising a carriage, wherein the carriage travels within the channel, and the winch is connected to platform to raise and lower the platform;
a base member supporting the elevating member; and
a rotating connection between the elevating member and the base member allowing the elevating member and the platform to rotate relative to the base member.

19. A method of using a lifting apparatus for an all-terrain vehicle, comprising:
providing a lifting apparatus comprising an elevating member comprising a platform, wherein the platform is movably engaged to the elevating member; a winch mounted on the elevating member, the winch connected to the platform to raise and lower the platform; a base member that supports the elevating member in a rotatable engagement such that the elevating member rotates relative to the base member;
operating the winch to lower the platform;
loading the platform with a load;
operating the winch to raise the platform; and
rotating the elevating member to position the load over the rear portion of the all-terrain vehicle.

20. A method of using a lifting apparatus for an all-terrain vehicle, comprising
providing a lifting apparatus, comprising: an elevating member that forms a channel, the elevating member comprising a winch; a platform comprising a carriage, wherein the carriage travels within the channel, and the winch is connected to platform to raise and lower the platform; and a rotating connection between the elevating member and the base member allowing the elevating member and the platform to rotate relative to the base member;
connecting the lifting apparatus to the all-terrain vehicle;
rotating the elevating member to position the platform over the rear portion of the all-terrain vehicle; and
lowering the platform to rest on the rear portion of the all-terrain vehicle.
